(19) United States
(12) Patent Application Publication
(10) Pub. No.: US 2024/0296752 A1
(43) Pub. Date: Sep. 5, 2024

(54) EXAMINATION QUESTIONS ANSWERING SYSTEM, EXAMINATION QUESTIONS ANSWERING METHOD, AND EXAMINATION QUESTIONS ANSWERING PROGRAM

(71) Applicant: HIROMICHI TOYAMA, TOKYO (JP)

(72) Inventor: HIROMICHI TOYAMA, TOKYO (JP)

(21) Appl. No.: 18/593,617

(22) Filed: Mar. 1, 2024

(30) Foreign Application Priority Data
Mar. 2, 2023 (JP) 2023-032154

(51) Int. Cl. G09B 7/06

(52) U.S. Cl. CPC G09B 7/06

(57) ABSTRACT

The invention provides an examination questions answering system including: a processing unit; and a storage unit, in which the storage unit stores examination information including a question number for each question item included in one unit of examination questions, the processing unit can display-process an examination screen for working on an examination question based on the examination information in response to a request from an answerer, the examination screen includes a list of answer fields for question items included in the one unit of the examination questions and operation elements in the answer field of each question item, and the processing unit can display the question of the question item corresponding to the operation element through the operation by the answerer, and display-processes the examination screen that can identify and display the answer field of the question item corresponding to the most recent operated operation element.

### FIELD OF THE DISCLOSURE

The present invention relates to an examination questions answering system, an examination questions answering method, and an examination questions answering program.

### BACKGROUND OF THE DISCLOSURE

Conventionally, there has been provided a system for answering examination questions by distributing examination question data from a server via Internet and inputting answers with a terminal.

For example, JP 2018-146799 A discloses a learning support system including: a processing unit that transmits input screen data including an input field for inputting an answer to a question; a data output unit that displays an input screen based on the input screen data; and a data input unit that transmits input data input to the input field, in which the processing unit includes: a determination part that determines whether the input data is correct or incorrect based on correct answer data including a correct answer to the question; and a correct/incorrect screen generation part that generates correct/incorrect screen data including correct/incorrect data indicating a determination result of the determination part.

### SUMMARY OF THE DISCLOSURE

For example, considering an examination screen in which answer fields for a plurality of question items are arranged side by side like a mark sheet type examination and a plurality of questions are arranged side by side on one question screen, a step of looking for a question from the question screen for each answer field and a step of checking correct answer field and inputting an answer are required. In addition, although it is necessary to check the answer field with each of the question screen and the answer field by scrolling operation, amounts of scrolling for both is not symmetrical, which also makes the check work complicated. In a case where the question and the answer field are displayed side by side for each question item, although a checking load is not required, an effect of grasping the amount of questions in the entire examination questions or enabling to overview the amounts of the answered/unanswered questions quickly is lost.

In addition, when working on an examination questions such as past exam questions or mock exam as preparation or working on a real examination, although the user typically answers question items in question order, some user may work on the examination questions by skipping a specific question depending on characteristics and question tendency of the examination questions. For example, in a case of examination questions with a large number of questions such as TOEIC (registered trademark), or in a case of working on examination questions in which a specific large question includes a difficult question, an odd question, or the like, a technique for working on the examination questions in consideration of pace allocation to answer an individual question item, a ratio of unanswered/answered to the entire examination questions, a question with the question tendency to be preferentially dealt with, and the like is also important. In the above described examination screen, the check work becomes particularly complicated in a case of answering by skipping questions or in a case of reconfirming answers that have been performed so far.

In view of the above circumstances, an object of the present invention is to provide an examination questions answering system that improves the efficiency of answering an examination questions.

In order to solve the above problem, the present invention provides an examination questions answering system supporting answering examination questions that includes: a processing unit; and a storage unit, in which the storage unit stores examination information including a question item number and question information indicating a question for each question item for each question item included in one unit of examination questions, the processing unit is configured so as to be capable of display processing of an examination screen for working on an examination question based on the examination information in response to a request from an answerer, the examination screen includes a list of answer fields for a plurality of question items included in the one unit of the examination questions and operation elements belonging to the answer field of each question item, and the processing unit is capable of displaying the question of the question item corresponding to the operation element through the operation of the operation element by the answerer, and performs the display processing of the examination screen being capable of identifying and displaying the answer field of the question item corresponding to the most recent operated operation element.

In addition, the present invention provides an examination questions answering program for supporting answering examination questions that causes a computer, which stores examination information including a question item number and question information indicating a question for each question item included in one unit of examination questions, to execute a step of display processing of an examination screen for working on an examination question based on the examination information in response to a request from an answerer, in which the examination screen includes a list of answer fields for a plurality of question items included in the one unit of the examination questions and operation elements belonging to the answer field of each question item, and in the step of display processing, the computer is capable of displaying the question of the question item corresponding to the operation element through the operation of the operation element by the answerer, and performs the display processing of the examination screen being capable of identifying and displaying the answer field of the question item corresponding to the most recent operated operation element.

In addition, the present invention provides an examination questions answering method for supporting answering examination questions, which is executed by a computer storing examination information including a question item number and question information indicating a question for each question item included in one unit of examination questions, that includes a step of display processing of an examination screen for working on an examination question based on the examination information in response to a request from an answerer, in which the examination screen includes a list of answer fields for a plurality of question items included in the one unit of the examination questions and operation elements belonging to the answer field of each question item, and in the step of display processing, the computer is capable of displaying the question of the question item corresponding to the operation element through the operation of the operation element by the answerer, and performs the display processing of the examination screen being capable of identifying and displaying the answer field of the question item corresponding to the most recent operated operation element.

In a preferred mode of the present invention, the processing unit does not display the question information stored for each question item when displaying the examination screen in response to the request from the answerer.

In a preferred mode of the present invention, the operation element is each question item number arranged side by side with the answer field.

With such a configuration, it is possible to work on efficiently a real examination questions conducted by computer based testing (CBT) or preparatory learning for a real examination questions. The registered question for each question item is displayed and the answer field corresponding to the question can be identified by operating the examination screen, which makes it extremely easy to check the answer field.

In a preferred mode of the present invention, the processing unit performs the display processing of the examination screen so that a question screen for displaying the question can be displayed in a different window from the examination screen when the operation element is operated.

In a preferred mode of the present invention, the processing unit updates question information displayed in the different window to question information relating to a question item corresponding to the operation element when another operation element is further operated in response to the request from the answerer in a state where the different window is opened.

With such a configuration, since it is possible to arbitrarily perform arranging, sizing, scaling, and the like of the answer field and the question, the examination questions can be used in a form easy for the answerer to work on.

In a preferred mode of the present invention, the question information includes a partition of the question item together with the number, and the examination screen includes a list of answer field for all question items included in the one unit of the examination questions, and displays the partition of each question item in a comprehensible manner.

With such a configuration, it is easy to answer question items with a specific partition preferentially or answer question items with a specific partition later.

The present invention can provide the examination questions answering system that improves the efficiency of answering the examination questions.

### BRIEF DESCRIPTION OF THE DRAWINGS

FIG. 1 is a block diagram illustrating a configuration of a system according to an embodiment;

FIGS. 2A and 2B are hardware configuration diagrams of the system according to the embodiment;

FIG. 3 is a functional block diagram of a device according to the embodiment;

FIGS. 4A to 4D are data configuration diagrams according to the embodiment;

FIG. 5 is a flowchart illustrating a learning procedure according to the embodiment;

FIGS. 6A and 6B are screen display examples according to the embodiment;

FIGS. 7A and 7B are screen display examples according to the embodiment; and

FIGS. 8A and 8B are screen display examples according to the embodiment.

### DETAILED DESCRIPTION OF THE EXEMPLARY EMBODIMENTS

Hereinafter, the present invention will be described in more detail with reference to the accompanying drawings. Preferred embodiment is illustrated in the drawings. However, it can be implemented in many different forms and is not limited to the embodiment described herein.

For example, in the present embodiment, although a configuration, an operation, and the like of an examination questions answering system 0 will be described, similar functions and effects can be achieved by a method, a device, a computer program, and the like to be executed. An examination questions answering program in the present embodiment may be provided as a non-transitory computer-readable recording medium or may be provided in a downloadable manner from an external server. In the present embodiment, a case where the examination questions answering program is started in an examination questions answering server 1 which is a server computer will be described.

### [System Configuration]

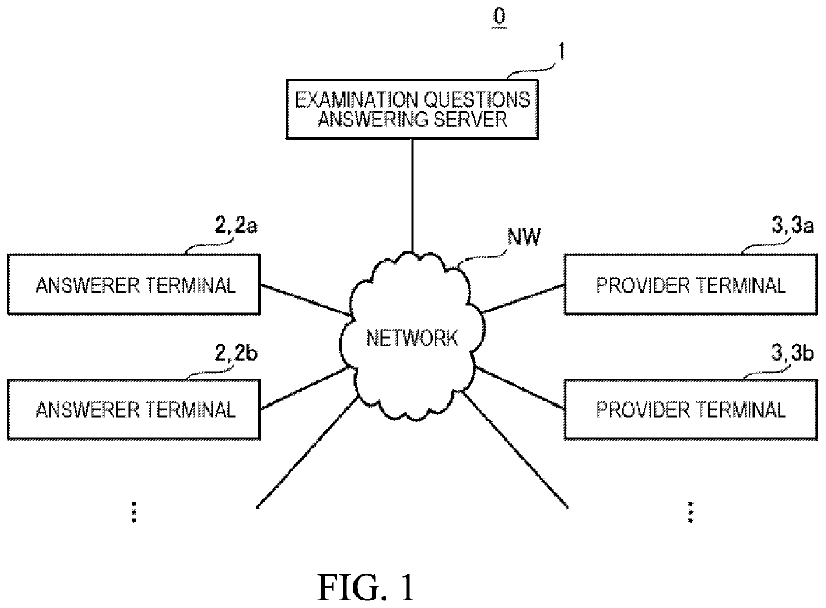

FIG. 1 is a block diagram illustrating a configuration of a system according to an embodiment. As illustrated in FIG. 1, the examination questions answering system 0 includes the examination questions answering server 1, a plurality of answerer terminals 2, and a plurality of provider terminals 3. The examination questions answering server 1 is configured to be able to communicate with the answerer terminals 2 and the provider terminals 3 via a network NW. Although the network NW is an Internet Protocol (IP) network in the present embodiment, a type of communication protocol is not limited, and the type and scale of the network are also not limited.

As the examination questions answering server 1, a computer for a general-purpose server, a personal computer, or the like can be used. It is also possible to configure the examination questions answering server 1 using a plurality of computers. As the answerer terminal 2 and the provider terminal 3, a smartphone, a tablet terminal, a personal computer, a wearable device, or the like can be used. Note that the answerer terminal 2 and the provider terminal 3 have an application for transmitting a request to the examination questions answering server 1 and receiving a response.

In the present embodiment, a case where the answerer terminal 2 and the provider terminal 3 access a learning platform via a web browser application and learning as a countermeasure for an examination is performed will be described. Therefore, the answerer terminal 2 and the provider terminal 3 have a web browser as an application. The answerer terminal 2 and the provider terminal 3 may have a native application for using the learning platform in order to access the learning platform. Note that the present invention is not limited to the learning application of the countermeasure for the examination, and can be used, for example, in examinations such as a real examination and a mock examination.

The answerer terminal 2 refers to a terminal used by a user (referred to as an answerer) who answers examination questions using a learning platform. The provider terminal 3 refers to a terminal used by a user (referred to as a provider) who registers the examination questions for learning. Typically, the provider is a publisher that sells learning content.

### [Hardware Configuration]

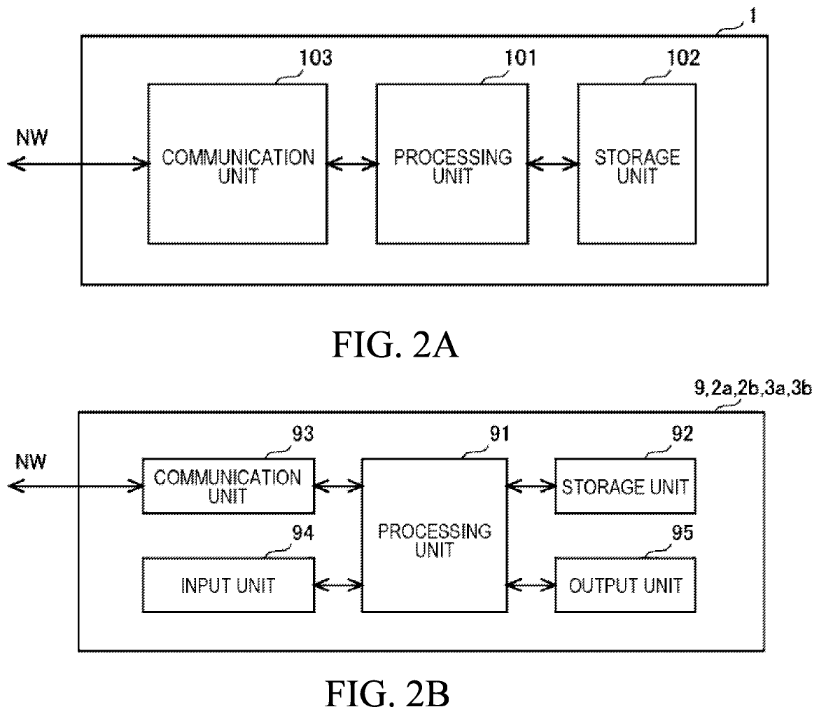

FIGS. 2A and 2B are hardware configuration diagrams according to the present embodiment. FIG. 2A is a diagram illustrating an example of a hardware configuration of the examination questions answering server 1. The examination questions answering server 1 includes a processing unit 101, a storage unit 102, and a communication unit 103 as a hardware configuration.

The processing unit 101 includes one or more processors such as a CPU, and controls the entire operation processing of the examination questions answering server 1 by executing the examination questions answering program, an OS, the web browser, and other applications according to the present invention.

The storage unit 102 is an HDD, a ROM, a RAM, or the like, and stores the examination questions answering program according to the present invention, data, and the like, used when the processing unit 101 executes processing based on the program. The processing unit 101 executes processing based on the examination questions answering program stored in the storage unit 102, thereby implementing a functional configuration described later.

The communication unit 103 executes communication control with the network NW and performs an input necessary for operating the examination questions answering server 1 and an output related to an operation result.

FIG. 2B is a diagram illustrating an example of a hardware configuration of a terminal 9 (the answerer terminal 2 and the provider terminal 3). The terminal 9 includes a processing unit 91, a storage unit 92, a communication unit 93, an input unit 94, and an output unit 95 as a hardware configuration.

The processing unit 91 of the terminal 9 includes one or more processors such as a CPU and controls the entire operation processing of the terminal 9. The storage unit 92 of the terminal 9 is an HDD, a ROM, a RAM, or the like, and stores a web browser application or the like for operating the examination questions answering server 1. The communication unit 93 of the terminal 9 controls communication with the network NW. The input unit 94 of the terminal 9 is a touch panel, a mouse, a keyboard, or the like, and inputs an operation request by the user to the processing unit 91. The output unit 95 of the terminal 9 is a display or the like, and displays a processing result or the like of the processing unit 91.

### [Functional Components of Examination Questions Answering Server 1]

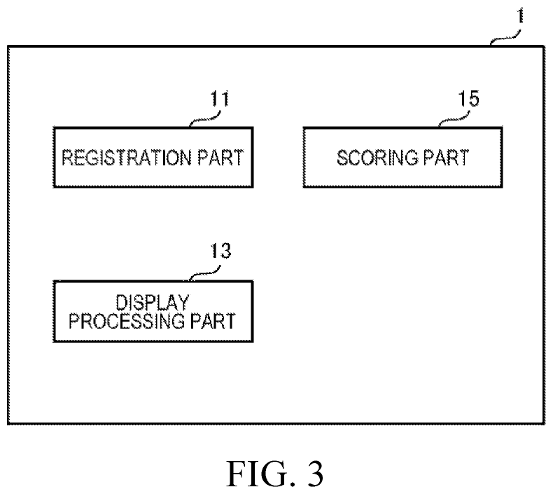

As illustrated in FIG. 3, the examination questions answering server 1 includes a registration part 11, a display processing part 13, and a scoring part 15 as functional components.

The registration part 11 stores information transmitted from the terminals in the storage unit 102. In the present embodiment, examination information is stored in the storage unit 102 based on the input from the provider terminal 3. In addition, history information including answers to examination questions is stored in the storage unit 102 based on the input from the answerer terminal 2.

### [Learning Platform]

In response to a request from the terminal 9, the display processing part 13 performs display processing of various screens and information of the learning platform using the resource information and/or necessary information, and returns a display processing result. In the present embodiment, the display processing part 13 provides various screens and information of the learning platform specified by a uniform resource locator (URL) and operated/managed so as to be browsable by the terminal 9 that has transmitted the request (desire). In the present embodiment, the storage unit 102 has resource information transmitted to the answerer terminal 2 and the provider terminal 3 to use the learning platform. In the present embodiment, the resource information may include, for example, a document described in a predetermined markup language (e.g., hyper text markup language (HTML)), cascading style sheets (CSS), a program (e.g., JavaScript (registered trademark)) operating on a web browser, an image, and the like.

### [Examination Information, Question Information]

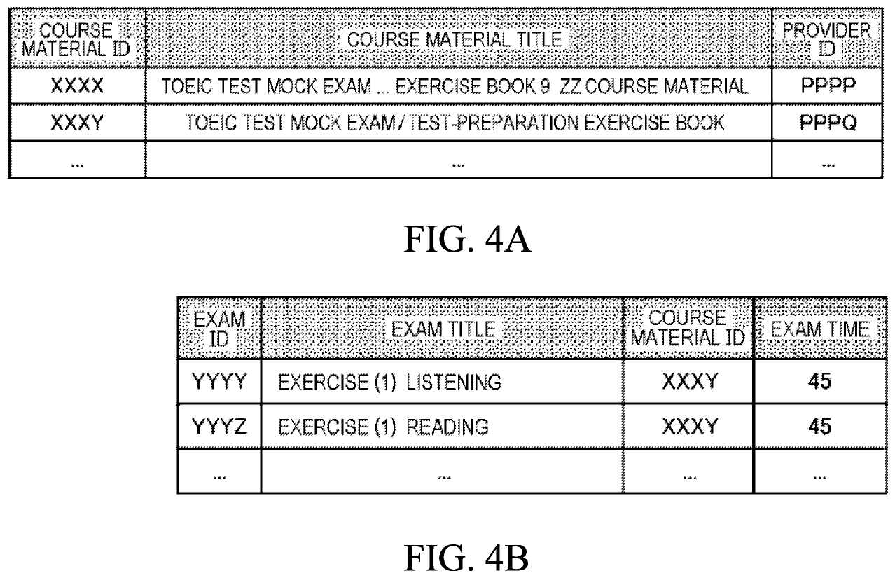

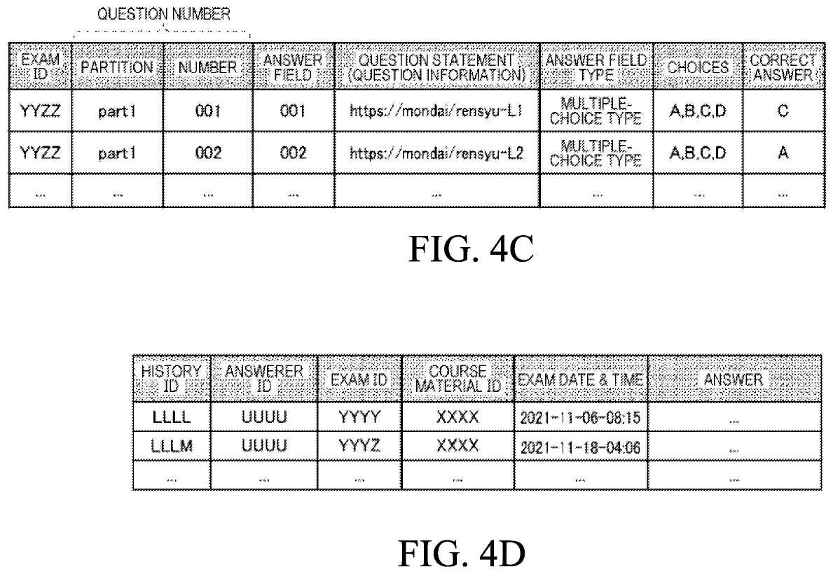

FIGS. 4A to 4D are data configuration diagrams of data stored in the storage unit 102. The examination information is information on one unit of examination questions. Although the unit of the examination questions is arbitrary, in the present embodiment, as illustrated in FIG. 4B, a test corresponding to listening of the TOEIC test (“Exercise (1) Listening” in FIG. 4B) and a test corresponding to reading (“Exercise (1) Reading” in FIG. 4B) are set as of the one unit examination questions. The one unit of examination questions may include, for example, both listening and reading. In another example, for example, each of the morning and afternoon examinations of Fundamental Information Technology Engineer Examination may be set as one unit of examination questions. The examination information further includes an examination time. Furthermore, a provider who is included in the teaching material illustrated in FIG. 4A and has registered the examination information (course material) is managed in association with the examination information.

The examination information includes information on a plurality of question items included in the examination questions. In the present embodiment, as illustrated in FIG. 4C, there are a question number (“Partition” and “Number” in FIG. 4C), question information (“Question statement” in FIG. 4C), an answer field type, choices, and a correct answer. The question number is information indicating the number of each question item, and in the present embodiment, the question number includes “Partition” corresponding to a large question or a section and “Number” of a question belonging to each partition. Note that the partition may include second and subsequent partitions for subdividing the partitions into two or more hierarchies, such as small questions. In addition, in a case where the number of the answer field and the number of the branch question are made different from each other, the second and subsequent partitions to be the numbers of the branch questions and the like may be further included. The choices indicate option candidates displayed in the answer field, and the correct answer indicates a correct answer option. In the present embodiment, although a case where the answer field type is a multiple-choice type will be described, it is preferable that an answer field such as a multiple selection type or a text input type can be set instead of or in addition to the multiple-choice type depending on the examination questions.

The question information is information for displaying a question (question content) set for each question item, and in the present embodiment, a URL of a web page containing questions is registered as the question information. The provider prepares the web page containing questions in advance, and registers the URL as the question information. For example, the questions may be described in an HTML file itself, or the questions may be configured to be able to be presented by a text file such as a portable document format (PDF), an image file, an audio file, a video file, or the like in a web page. The resource information for displaying the web page containing the questions may be stored in an external web server accessible from the answerer terminal 2 via the network NW, or may be stored in the examination questions answering server 1 (storage unit 102).

### [Learning Procedure]

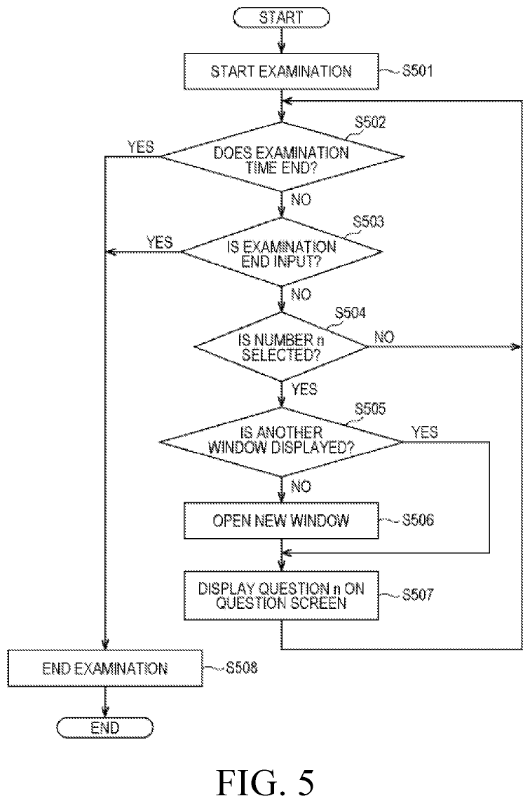

Next, the procedure of learning using the examination questions answering system 0 will be described in detail with reference to FIGS. 5 to 8B. FIG. 5 is a flowchart illustrating a learning procedure.

### [Top Page]

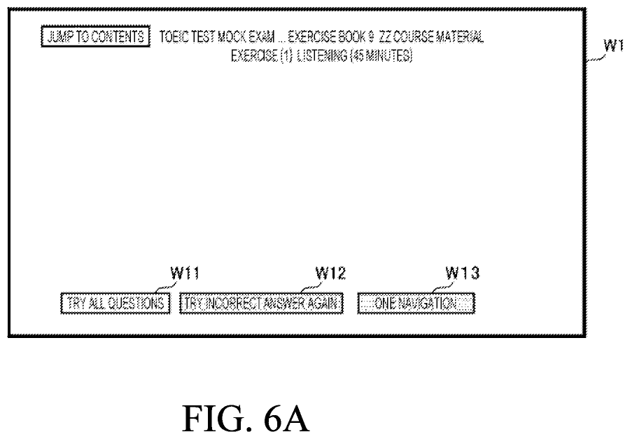

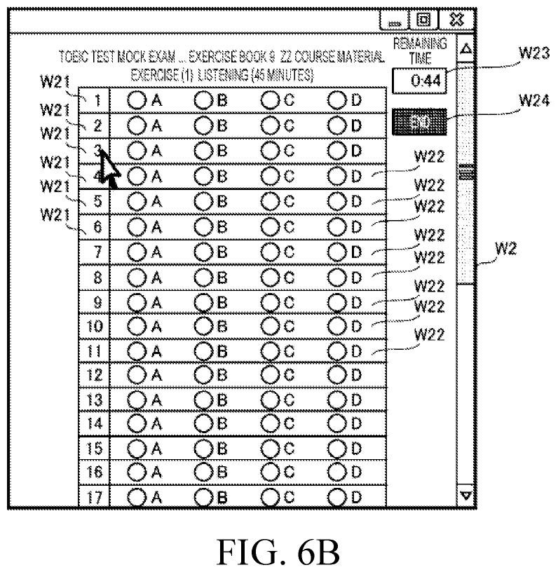

In S501, the answerer specifies a learning method and starts the examination. First, when receiving specification of an examination question to be learned from the answerer terminal 2, the display processing part 13 performs display processing of a top page W1 of the examination questions illustrated in FIG. 6A and displays the top page W1 on the answerer terminal 2. The top page W1 includes a try all questions button W11, a try incorrect answer again button W12, and a try important question again button W13 (one navigation button).

When the examination questions are worked on for the first time, one or both of the try incorrect answer again button W12 and the try important question again button W13 are disabled so as not to be selectable or are not displayed. When the answerer presses the try all questions button W11, the answerer terminal 2 transmits a display processing request of an examination screen on which answers can be input to all questions included in the examination questions (hereinafter, referred to as “examination screen (all)”), to the examination questions answering server 1. The display processing part 13 performs display processing of an examination screen for working on the learning using the examination questions based on the examination information in response to the request from the answerer (the answerer terminal 2), and transmits a display processing result. The web browser of the answerer terminal 2 that has received the display processing result displays the resource information and necessary information (examination name, time, question number, and the like included in the examination information) received as the display processing result, thus the answerer can start the examination.

### [Examination Screen]

FIG. 6B is a screen display example of the examination screen (all). The examination screen W2 includes a question item number W21, an answer field W22 for a plurality of question items included in one unit of examination questions, a time display portion W23, and an end button W24. In the present embodiment, the answer fields W22 for all the question items included in the specified examination information are displayed as a list on one screen. The question items outside the screen can be displayed by a scrolling operation. The remaining time from the start of the examination is displayed in the time display portion W23 based on the examination time, and the answerer inputs the answer in the answer field W22 during the examination time.

In S502, it is determined whether the examination time ends. When the examination time ends (YES in S502), the process proceeds to S508 to end the examination. When the end button W24 is pressed in S503 (YES in S503), the process proceeds to S508 to end the examination. When the examination is ended, the registration part 11 accepts the inputs made in the answer fields W22, and stores the answers, the examination information, and the like in the storage unit 102 as history information associated with each other. FIG. 4D is an example of the history information. In addition, the scoring part 15 scores the answer stored as the history information based on the correct answer of the examination information and determines whether or not the answer is correct.

### [Question Screen]

The examination screen W2 includes an operation element associated with the answer field W22 of each question item, and can display a question in a window different from the examination screen W2 according to the question item corresponding to the operation element when the operation element is operated by the answerer, and further, can identify and display the answer field W22 of the question item corresponding to the most recent operated operation element. In the present embodiment, the number W21 on the examination screen W2 is the operation element. As an example, the resource information of the examination screen W2 includes a program described in client-side original language such as JavaScript, and when the operation element (number W21) is specified, the web browser of the answerer terminal 2 opens another window or updates the question displayed in another window based on the program, and colors the answer field W22 of the question corresponding to the most recent operated operation element.

In S501, the answerer selects and operates the try all questions button W11, the try incorrect answer again button W12, or the try important question again button W13 to specify the learning method and start the examination. When receiving the start request of the examination, the display processing part 13 returns the resource information of the examination screen W2 including the question information stored for each of the plurality of (In the present embodiment, all) question items included in the examination questions to the answerer terminal 2 as the display processing of the examination screen W2. At this time, the question information is embedded as a hyperlink that can be specified as an operation element on the examination screen W2, and is not immediately displayed on the examination screen W2.

In S504, when the operation element (number W21) is operated, the processing unit 91 of the answerer terminal 2 displays a question screen for displaying a question according to the question item corresponding to the operation element in a window different from the examination screen W2. In addition, the processing unit 91 of the answerer terminal 2 identifies and displays the answer field of the question item corresponding to the most recent operated operation element (number W 21).

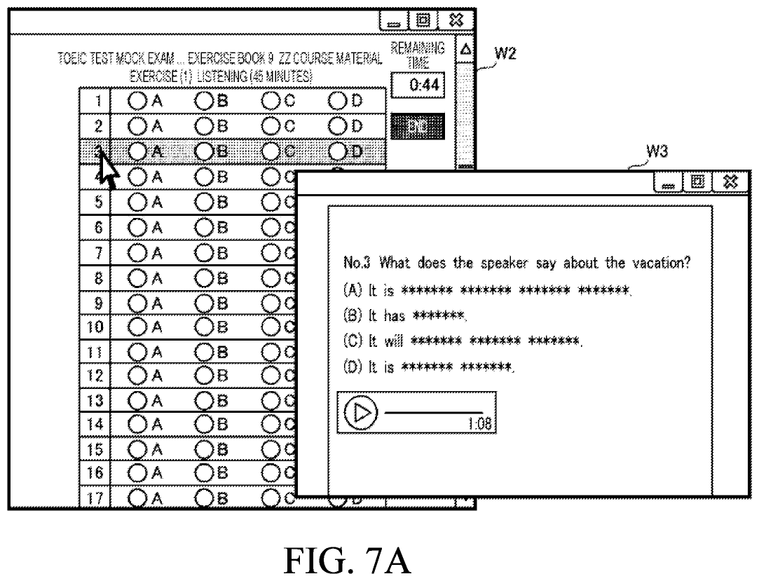

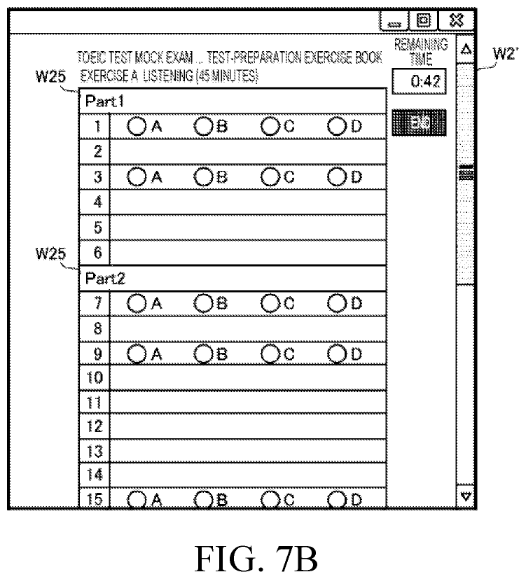

FIG. 7A illustrates a screen display example of the question screen W3. In the illustrated example, a third question is operated on the examination screen W2, and the operated third question is displayed on the question screen W3. Furthermore, in the illustrated example, the portion of the number W21 corresponding to the question item number 3 and the answer field W22 are colored, and are displayed so as to be distinguishable from the numbers W21 and the answer fields W22 corresponding to other questions. Note that a method of identifying and displaying is arbitrary, and for example, a cursor pointing to the number W21 or the answer field W 22 may be displayed, or a frame line of the number W21 or the answer field W22 may be changed.

When a window different from the examination screen W2 is not opened when the operation element (number W21) is operated in S504 (NO in S505), the processing unit 91 of the answerer terminal 2 opens a new window (S506) and displays the question screen W3 (S507). On the other hand, in a case where a window different from the examination screen W2 is already opened when the operation element is operated in S504 (YES in S505), the process proceeds to S507, and the processing unit 91 of the answerer terminal 2 updates the question already displayed in the different window based on the question information (URL) relating to the question item corresponding to the operation element.

In the question screen W3, an operation element such as a button for displaying the question of the next number and/or the previous number may be arranged. When the operation element is operated to update the question on the question screen to the next/previous question, the processing unit 91 of the answerer terminal 2 may also identify and display the number of the updated question on the examination screen W2. For example, when the operation element (number W21) is operated, the processing unit 91 of the answerer terminal 2 transmits a display processing request of the question screen W3 including the question information (URL) to the display processing part 13. The display processing part 13 performs the display processing on the question screen W3 in which the content of the web page accessible by the question information (URL) is embedded, and returns a display processing result.

### [Rechallenge to Incorrectly Answered Questions]

In addition, the answerer can challenge the incorrectly answered questions again based on the scoring result by the scoring part 15 after the entire examination questions is completed. By pressing the try incorrect answer again button W12 on the top page W1, an examination screen displaying answer fields of all the incorrectly answered question items is displayed, and the incorrectly answered questions can be challenged again. An importance level may be set for each question item included in the examination information by the provider or the like, and by pressing the try important question again button W13 on the top page W1, an examination screen displaying only an answer field of one question having the highest importance level among incorrectly answered questions is displayed, then the most important question that has been answered incorrectly can be challenged again.

FIG. 7B is an example of an examination screen W2′ displayed by pressing the try incorrect answer again button W12 for another examination questions. Note that the examination screen W2′ is displayed so that the partition of each question item included in one unit of examination questions can be grasped. In the illustrated example, the partition W25 is displayed so that the section to which the number of each question item belongs can be grasped. Note that the partition W25 may be displayed by an arbitrary arrangement/expression method such as displaying it side by side with the number W22 of each question item.

### [Registration of Question Information]

The provider terminal 3 requests the examination questions answering server 1 to perform display processing on a question management screen when the provider registers the question information. The display processing part 13 performs display processing on the question management screen and returns a display processing result.

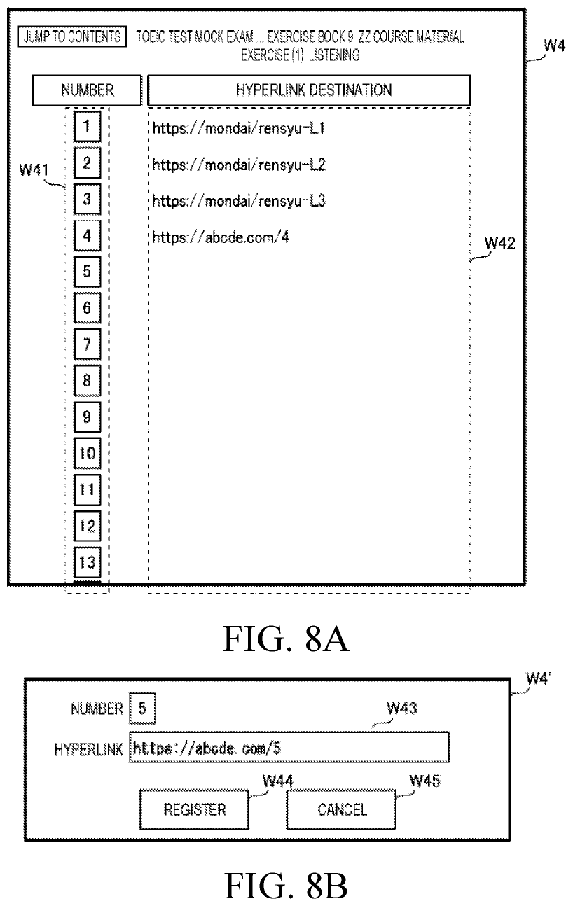

FIG. 8A is a screen display example of the question management screen when the provider registers the question information. A question management screen W4 includes a number selection portion W41 and a hyperlink display portion W42. The provider operates the input unit 94 of the provider terminal 3 to select the number selection portion W41. When the number selection portion W41 is selected, the display processing part 13 displays a question registration screen W4′ as illustrated in FIG. 8B.

The question registration screen W4′ includes a question input portion W43, a register button W44, and a cancel button W45. The provider operates the input unit 94 of the provider terminal 3 to input the URL of the web page containing the question to the question input portion W43, and presses the register button W44. The registration part 11 receives registration of the question information for each question item from the provider terminal 3 and stores it in the storage unit 102. When the cancel button W45 is pressed, the question registration screen W4′ is closed.

Although the question information is a URL in the present embodiment, a text or a file indicating a questions may be configured to be able to be registered.

### REFERENCE SIGNS LIST

0 examination questions answering system
1 examination questions answering server
11 registration part
13 display processing part
15 scoring part
101 processing unit
102 storage unit
103 communication unit
2 answerer terminal
3 provider terminal
9 terminal
91 processing unit
92 storage unit
93 communication unit
94 input unit
95 output unit

What is claimed is:

1. An examination questions answering system supporting answering examination questions, the examination questions answering system comprising:
a storage unit, and
a processing unit connected to the storage unit,
wherein the storage unit stores examination information including a question number indicating a number of a question item for each question item included in one unit of examination questions, and
wherein the processing unit is configured to:
receive an input of a hyperlink for displaying a question for each of the question numbers from a provider registering an examination question in the storage unit, relates the hyperlink to the question number, and register the question number and the hyperlink in the storage unit,
perform display processing of an examination screen for working on an examination question based on the examination information on a terminal of an answerer in response to a request from the answerer,
the examination screen includes a list of answer fields in which answers to a plurality of question items included in the one unit of the examination questions can be input, and a plurality of operation elements belonging to the answer field of each question item,
the answer field is included only in the examination screen, and
perform display processing of the question of the question item corresponding to the operation element on the terminal of the answerer through the operation of the operation element by the answerer, and performs the display processing of the examination screen identifying and displaying the answer field of the question item corresponding to the most recent operated operation element on the terminal of the answerer.

2. The examination questions answering system according to claim 1,
wherein the processing unit configured to perform display processing of the examination screen so that a question screen for displaying the question is displayed in a different window from the examination screen when the operation element is operated.

3. The examination questions answering system according to claim 2,
wherein the processing unit configured to perform display processing of the question screen to be superimposed on the examination screen in a state where the plurality of operation elements included in the examination screen is visually recognized when the operation element is operated.

4. The examination questions answering system according to claim 2,
wherein the processing unit configured to update a question displayed in the different window to a question relating to a question item corresponding to the operation element when another operation element is further operated in response to the request from the answerer in a state where the different window is opened.

5. The examination questions answering system according to claim 1,
wherein the question number includes a partition of the question item, and the examination screen includes a list of answer field in which the answers to all question items included in the one unit of the examination questions can be input, and displays the partition of each question item in a comprehensible manner.

6. A non-transitory computer readable medium recorded an examination questions answering program for supporting answering examination questions, when executed causes a processing unit connected to a storage unit that storing examination information including a question number indicating a number of a question item for each question item included in one unit of examination questions, to execute processing comprising:
receiving an input of a hyperlink for displaying a question for each of the question numbers from a provider registering an examination question to the storage unit, relating the hyperlink to the question number, and registering the question number and the hyperlink to the storage unit; and
performing display processing of an examination screen on a terminal of an answerer for working on an examination question based on the examination information in response to a request from the answerer,
wherein the examination screen includes a list of answer fields in which answers to a plurality of question items included in the one unit of the examination questions can be input, and a plurality of operation elements belonging to the answer field of each question item,
the answer field is included only in the examination screen, and
in the display processing, the processing unit displays the question of the question item corresponding to the operation element on the terminal of the answerer through the operation of the operation element by the answerer, and performs the display processing of the examination screen identifying and displaying the answer field of the question item corresponding to the most recent operated operation element.

7. An examination questions answering method for supporting answering examination questions,
the method being executed by a processing unit connected to a storage unit;
wherein the storage unit storing examination information including a question number indicating a number of a question item for each question item included in one unit of examination questions:
receiving, by the processing unit, an input of a hyperlink for displaying a question for each of the question numbers from a provider registering an examination question to the storage unit, relating the hyperlink to the question number, and registering, by the processing unit, the question number and the hyperlink to the storage unit; and
performing, by the processing unit, display processing of an examination screen on a terminal of an answerer for working on an examination question based on the examination information in response to a request from the answerer,
wherein the examination screen includes a list of answer fields in which answers to a plurality of question items included in the one unit of the examination questions can be input, and a plurality of operation elements belonging to the answer field of each question item,
the answer field is included only in the examination screen, and
performing, by the processing unit, display processing the question of the question item corresponding to the operation element on the terminal of the answerer through the operation of the operation element by the answerer, and performing display processing of the examination screen identifying and displaying the answer field of the question item corresponding to the most recent operated operation element.
